(19) United States
(12) Patent Application Publication
(10) Pub. No.: US 2007/0267980 A1
(43) Pub. Date: Nov. 22, 2007

(54) DRIVING CIRCUIT FOR MULTIPLE DISCHARGE LAMPS

(75) Inventor: Shih-Hsien Chang, Taoyuan (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc., Taoyuan (TW)

(21) Appl. No.: 11/559,502

(22) Filed: Nov. 14, 2006

(30) Foreign Application Priority Data
May 16, 2006 (TW) 095117327

(51) Int. Cl. H05B 41/16; H05B 41/24

(52) U.S. Cl. 315/274

(57) ABSTRACT

Presented is a driving circuit for multiple discharge lamps, including a plurality of transformers having a plurality of primary windings and secondary windings, in which each secondary winding is connected in series with a resonance circuit and each resonance circuit is coupled to a discharge lamp. The driving circuit further includes an additional resonance inductor coupled to the primary side of the transformers for increasing the resonance inductance of the resonance circuit and allowing the resonance inductance of the resonance circuit to be modulated in response to the variation of the impedance of the discharge lamp or the variation of the impedance of the resonance capacitor of the resonance circuit.

### FIELD OF THE INVENTION

The present invention is related to a driving circuit for multiple discharge lamps, and more particularly to a driving circuit for multiple discharge lamps that includes an additional resonant inductor for adjusting the resonant inductance of the resonant circuit within the driving circuit.

### BACKGROUND OF THE INVENTION

Generally speaking, a liquid crystal display requires a backlight module to provide backlighting for illuminating the liquid crystal display. When it is desired to display images on the liquid crystal display, the light source within the backlight module can generate light beams that pass through the case of the backlight module, thereby providing a uniform illumination to the liquid display panel for enabling the liquid crystal display to form the required images. Nowadays, the light source used in the backlight module is implemented by discharge lamps, for example, cold cathode fluorescent lamps. Generally, cold cathode fluorescent lamps are driven by a driving circuit that is configured to provide a high-frequency AC voltage to lamps and includes a feedback control circuit to stabilize lamp currents. In the applications of liquid crystal display, one or more discharge lamps are required to provide sufficient backlighting.

FIG. 1 is a circuit diagram showing the circuitry of a conventional driving circuit for multiple discharge lamps. The driving circuit of FIG. 1 includes a switch device 10, a control circuit 12, a plurality of transformers T₁-T_{N}, and a plurality of series resonant circuits connected to the secondary side of the transformers T₁-T_{N} for illuminating a plurality of discharge lamps Lp₁-Lpₖ. The switch device 10 is configured to receive an input DC voltage Vin and convert the input DC voltage Vin into an AC voltage through the repeated on/off operations. The transformers T₁-T_{N} are configured to boost the AC voltage into a desired AC voltage so as to drive the discharge lamps Lp₁-Lpₖ. The transformers T₁-T_{N} include a N primary windings and k secondary windings, where k is equal to or larger than N. Primary leakage inductance Lkₚ₁-Lk_{pN} and secondary leakage inductance Lkₛ₁-Lkₛₖ are respectively existed on the primary side of the transformers T₁-T_{N} and the secondary side of the secondary side of the transformers T₁-T_{N.} Resonant capacitance Cp₁-Cpₖ are placed on the secondary side of the transformers T₁-T_{N} that can be implemented by the parasitic capacitance of the discharge lamps Lp₁-Lpₖ. The resonant capacitance Cp₁-Cpₖ and the leakage inductance of the transformers T₁-T_{N} form a plurality of series resonant circuits, which is configured to illuminate the discharge lamps Lp₁-Lpₖ through the resonance between the resonant capacitance Cp₁-Cpₖ and the leakage inductance of the transformers T₁-T_{N}. Moreover, the inductance of the leakage inductance of the transformers T₁-T_{N} and the capacitance of the resonant capacitance Cp₁-Cpₖ can be adjusted to achieve impedance matching between the transformers T₁-T_{N} and the discharge lamps Lp₁-Lpₖ, thereby balancing the currents flowing through the discharge lamps Lp₁-Lpₖ.

FIG. 2 is the equivalent circuit diagram of FIG. 1, in which the primary leakage inductance Lkₚ₁-Lk_{pN} of the transformer T₁-T_{N} are mapped to the secondary side of the transformer T₁-T_{N.} According to the impedance transformation theorem of transformer, the leakage inductance formed at the secondary side of the transformer T₁-T_{N} that are resulted from the mapping of the primary leakage inductance of the transformer T₁-T_{N} are:

Lkₚ₁×n², . . . Lkₚₖ×n²

Where n is the turn ratio of the transformers T₁-T_{N}. Therefore, the leakage inductance of the transformers T₁-T_{N} are:

(Lkₚ₁×n²+Lkₛ₁), . . . (Lkₚₖ×n²+Lkₛₖ)

Therefore, the leakage inductance of the transformers T₁-T_{N} can resonate with the resonant capacitance Cp₁-Cpₖ to illuminate the discharge lamps Lp₁-Lpₖ.

However, when the impedance of the discharge lamps Lp₁-Lpₖ or the impedance of the resonant capacitance Cp₁-Cpₖ is changed, the leakage inductance of the transformers T₁-T_{N} have to be adjusted to allow the series resonance circuits to operate under a desired resonance frequency. Because the leakage inductance of the transformers T₁-T_{N} are related with the turn number of the windings of the transformers T₁-T_{N}, the turn number of the windings of the transformers T₁-T_{N} has to be adjusted to obtain the desired leakage inductance under this condition. Because the number of the transformers T₁-T_{N} is large, the turn number of the windings of each transformer has to be adjusted one by one, which would lead to the inconvenience and trouble in circuit design.

Therefore, there is a need to develop a driving circuit for multiple discharge lamps that can adjust the resonate inductance of the series resonant circuits in response to the change of the impedance of the discharge lamps or the change of the resonant capacitance of the series resonant circuits.

### SUMMARY OF THE INVENTION

An object of the present invention is to provide a driving circuit for multiple discharge lamps that can allow the resonant inductance of the resonant circuits within the driving circuit to be flexibly adjusted.

Another object of the present invention is to provide a driving circuit for multiple discharge lamps that can provide an enhanced driving capability to drive discharge lamps.

To this end, the present invention provides a driving circuit for multiple discharge lamps, including a plurality of transformers, each transformer includes a primary winding and at least one secondary winding, a plurality of resonant circuits, each resonant circuit is connected in series with a secondary winding, a plurality of discharge lamps, each discharge lamp is coupled with a resonant circuit, and an inductive element connected to the primary side of the transformers, in which the resonant inductance of the resonant circuit can be adjusted through the inductive element.

Now the foregoing and other features and advantages of the present invention will be best understood through the following descriptions with reference to the accompanying drawings, wherein:

### BRIEF DESCRIPTION OF THE DRAWINGS

FIG. 1 is a circuit diagram showing the conventional driving circuit for multiple discharge lamps according to the prior art;

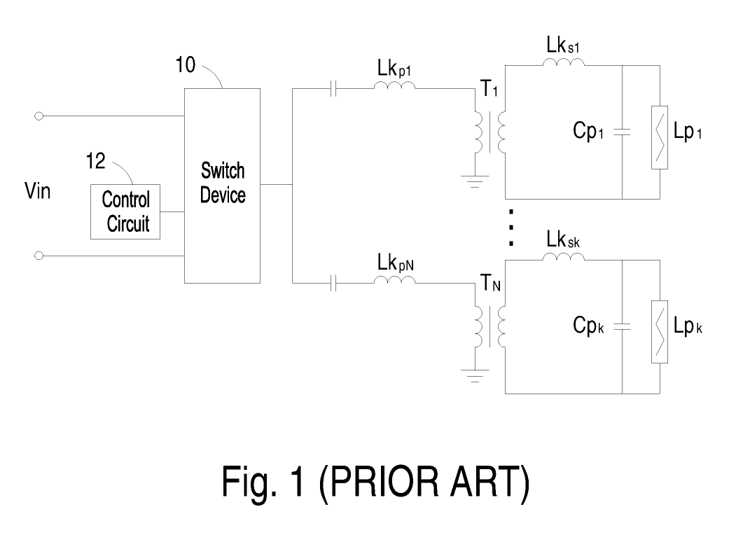

FIG. 2 is an equivalent circuit diagram of FIG. 1;

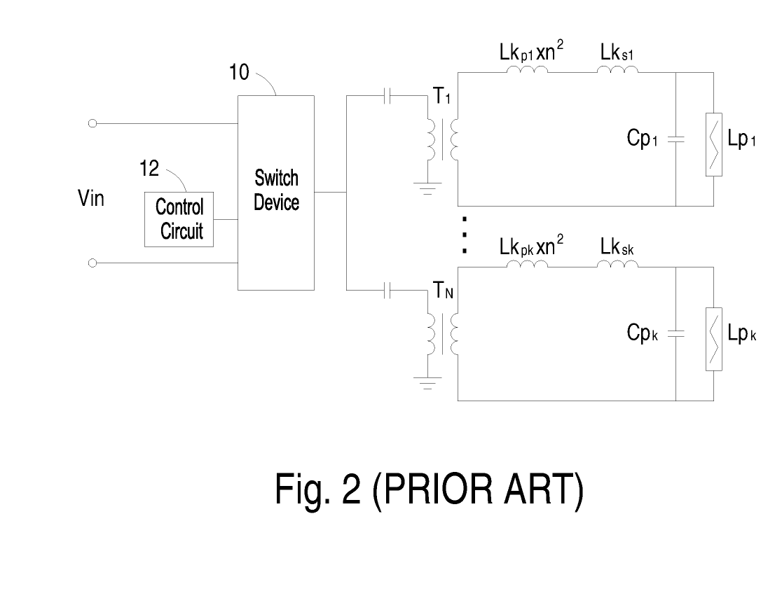

FIG. 3 is a circuit diagram showing a driving circuit for multiple discharge lamps according to a preferred embodiment of the present invention;

FIG. 4 is an equivalent circuit diagram of FIG. 3;

FIG. 5 is a diagrammatic view illustrating the step of transforming the driving circuit of FIG. 4 into an equivalent circuit; and

FIG. 6 is an equivalent circuit diagram of FIG. 4.

### DETAILED DESCRIPTION OF THE PREFERRED EMBODIMENT

A preferred embodiment embodying the features and advantages of the present invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

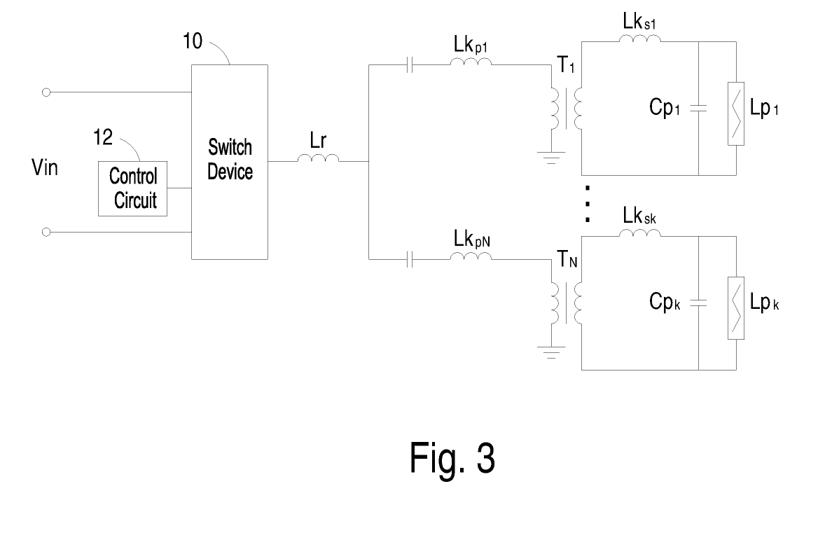

A preferred embodiment of the present invention will be illustrated with reference to FIG. 3. FIG. 3 shows a circuit diagram of a driving circuit for multiple discharge lamps according to the present invention. It should be noted that the same reference numeral indicates the same circuit element throughout the present invention. The driving circuit shown in FIG. 3 includes a switch device 10, a control circuit 12, a plurality of transformers T₁-T_{N}, and a plurality of series resonant circuits connected to the secondary side of the transformers T₁-T_{N} for illuminating a plurality of discharge lamps Lp₁-Lpₖ. The switch device 10 is configured to receive an input DC voltage Vin and convert the input DC voltage Vin into an AC voltage by repeated on/off operations. The control circuit 12 is configured to control the on/off operations of the switch device 10. The transformers T₁-T_{N} are configured to boost the AC voltage into a desired AC voltage for driving the discharge lamps Lp₁-Lpₖ. The primary side and the secondary side of the transformers T₁-T_{N} are respectively provided with primary leakage inductance Lkₚ₁-Lk_{pN} and secondary leakage inductance Lkₛ₁-Lkₛₖ. The secondary side of the transformers T₁-T_{N} is provided with resonant capacitance Cp₁-Cpₖ being implemented by the parasitic capacitance of the discharge lamps Lp₁-Lpₖ. The resonance capacitance Cp₁-Cpₖ and the resonant inductance formed at the secondary side of the transformer T₁-T_{N} form a plurality of series resonant circuits so as to allow the resonance between the resonance capacitance Cp₁-Cpₖ and the resonant inductance. Besides, an additional resonance inductor Lr is placed between the output terminal of the switch device 10 and the primary side of the transformers T₁-T_{N}. As to the function and operation of the additional resonance inductor Lr, they will be described in detail in the following paragraphs.

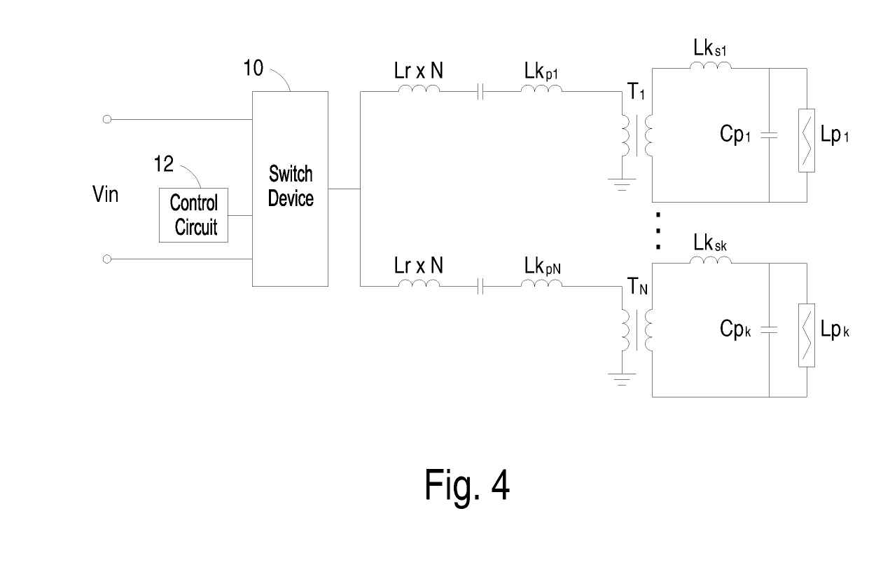

FIG. 4 is the equivalent circuit diagram of FIG. 3. The topology of the driving circuit of FIG. 4 is derived by decomposing the additional resonance inductor of FIG. 3 into a plurality of equivalent inductors. According to the formula for calculating the inductance of inductors being connected in parallel, the additional resonance inductor is equivalent to the parallel combination of branch inductors each connected to the primary side of a respective transformer, in which the inductance of each branch inductor is:

Lr×N

Where N is the number of the transformers.

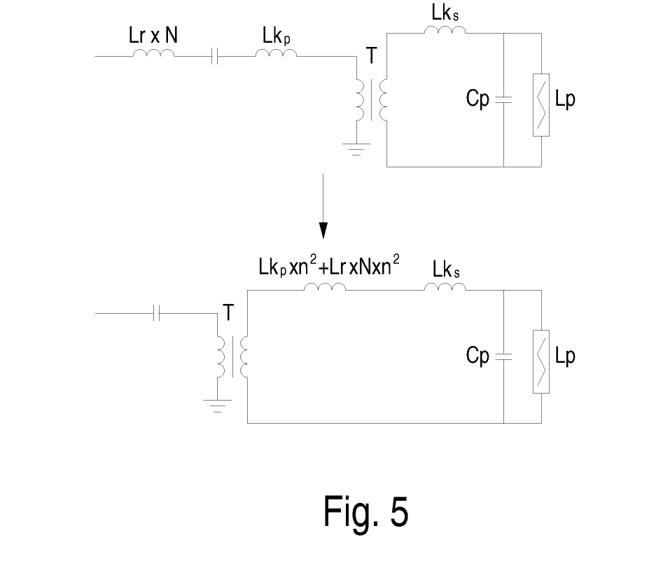

FIG. 5 is a plan view illustrating the steps for transforming the driving circuit of FIG. 4 into an equivalent circuit. As shown in FIG. 5, each branch inductor and primary leakage inductance are mapped to the secondary side of the transformers T₁-T_{N}. According to the theorem of impedance transformation for transformer, the inductance formed at the secondary side of the transformers T₁-T_{N} that is resulted from of the mapping of the branch inductors to the secondary side of the transformers T₁-T_{N} will be:

Lr×N×n²

Where n is the turn ratio of the transformers T₁-T_{N}. Therefore, the inductance formed at the secondary side of the transformer T₁-T_{N} that is resulted from the mapping of the inductance formed at the primary side of the transformers T₁-T_{N} will be:

(Lkₚ₁×n²+Lr×N×n²), . . . (Lkₚₖ×n²+Lr×N×n²)

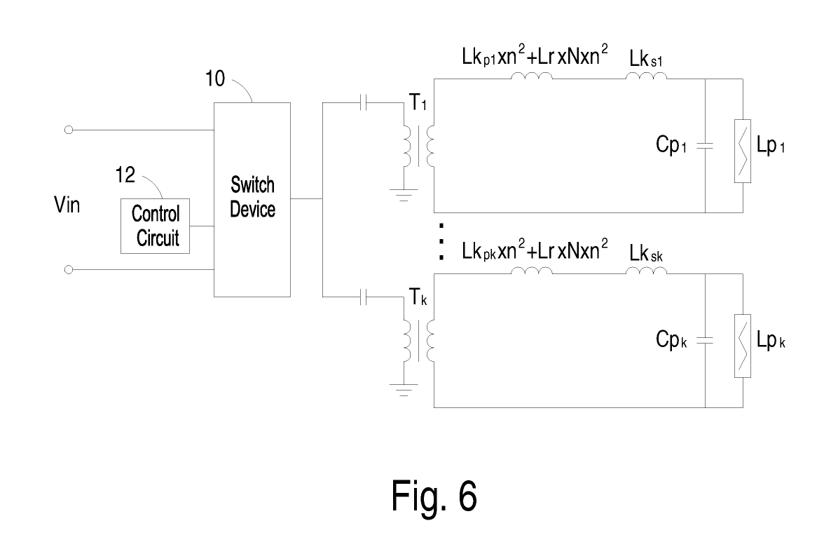

FIG. 6 is the equivalent circuit diagram of FIG. 4. The equivalent circuit of FIG. 6 is derived by transforming the driving circuit of FIG. 4 with reference to the transforming step illustrated in FIG. 5. It can be understood from FIG. 6 that the resonance inductance at the secondary side of the transformers T₁-T_{N} will be:

(Lkₚ₁×n²+Lr×N×n²+Lkₛ₁), . . . (Lkₚₖ×n²+Lr×N×n²+Lkₛₖ)

Therefore, the resonant inductance formed at the secondary side of the transformers T₁-T_{N} can resonate with the resonant capacitance Cp₁-Cpₖ, and thereby illuminating the discharge lamps Lp₁-Lpₖ.

It can be understood from the above statements that the inventive driving circuit for multiple discharge lamps includes an additional resonant inductor being coupled to the primary side of the transformers T₁-T_{N}, so that the resonant inductance of the resonant circuit within the driving circuit can be adjusted by adjusting the inductance of the additional resonant inductor, without the need of adjusting the turn number of the transformer windings of each transformer for adjusting the leakage inductance of the transformer. In addition, when it is desired to illuminate the discharge lamps, a larger resonant inductance would be required. It can be known from the above discussion that the resonant inductance of the resonant circuit within the inventive driving circuit will be larger than the resonant inductance of the resonant circuit within the conventional driving circuit by Lr×N×n². Thus, if the inventive driving circuit is used to illuminate multiple discharge lamps, the driving capability of the driving circuit can be dramatically enhanced and the number of the discharge lamps for which the driving circuit can drive can be increased.

Those of skilled in the art will recognize that these and other modifications can be made within the spirit and scope of the present invention as further defined in the appended claims.

What is claimed is:

1. A driving circuit for multiple discharge lamps, comprising:
a plurality of transformers, each transformer includes a primary winding and at least one secondary winding;
a plurality of resonant circuits, each resonant circuit is connected in series with a secondary winding;
a plurality of discharge lamps, each discharge lamp is coupled to a resonant circuit; and
an inductive element coupled to the primary side of the plurality of transformers.

2. The driving circuit for multiple discharge lamps according to claim 1 wherein each resonant circuit includes a resonant capacitance being implemented by a parasitic capacitance of the discharge lamp.

3. The driving circuit for multiple discharge lamps according to claim 2 wherein each resonant circuit includes a resonant inductance being implemented by the leakage inductance of the transformer.

4. The driving circuit for multiple discharge lamps according to claim 3 wherein the inductance of the resonant inductance is adjusted through the inductive element.

5. The driving circuit for multiple discharge lamps according to claim 1 further comprising a switch device coupled to the primary side of the plurality of transformers.

6. The driving circuit for multiple discharge lamps according to claim 5 further comprising a control circuit coupled to the switch device for controlling the on/off operations of the switch device.

7. A driving circuit for multiple discharge lamps, comprising:
a plurality of transformers, each transformer includes a primary winding and at least one secondary winding;
a switch device coupled to the primary side of the plurality of transformers;
a plurality of resonant circuits, each resonant circuit is connected in series with a secondary winding;
a plurality of discharge lamps, each discharge lamp is coupled with a resonant circuit; and
a resonant element coupled between the switch device and the primary side of the plurality of transformers, wherein the resonance of the plurality of resonant circuits is adjusted through the resonant element.

8. The driving circuit for multiple discharge lamps according to claim 7 further comprising a control circuit coupled to the switch device for controlling the on/off operations of the switch device.

9. The driving circuit for multiple discharge lamps according to claim 7 wherein each resonant circuit includes a resonant capacitance being implemented by a parasitic capacitance of the discharge lamp.

10. The driving circuit for multiple discharge lamps according to claim 9 wherein each resonant circuit includes a resonant inductance being implemented by the leakage inductance of the transformer.

11. The driving circuit for multiple discharge lamps according to claim 10 wherein the inductance of the resonance inductance is adjusted through the resonant element.

12. The driving circuit for multiple discharge lamps according to claim 11 wherein the resonant element is an inductive element.
